(19) United States
(12) Patent Application Publication
(10) Pub. No.: US 2008/0247800 A1
(43) Pub. Date: Oct. 9, 2008

(54) Method For Visualizing a Use Section and at Least One Cutoff Section

(75) Inventor: Dieter Reichhart, Eschweiler (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: HIFLEX SOFTWARE GESMBH, Wien (AT)

(21) Appl. No.: 11/817,900

(22) PCT Filed: Mar. 2, 2006
(86) PCT No.: PCT/EP2006/001911

§ 371 Date: Sep. 6, 2007

(30) Foreign Application Priority Data
Mar. 7, 2005 (DE) 10 2005 010 819.9

(51) Int. Cl. B41J 15/00; G06K 15/00

(52) U.S. Cl. 400/578; 358/1.18

(57) ABSTRACT

method for visualizing a use section (6) and at least one cutoff section (14) through a program for graphic production on an output device of a computer, wherein the use section (6) has an end format of a print product, and a page of the print product can be printed in the use section (6), and the cutoff section (14) abuts to an edge (15) of the use section (6), and has an elongated shape along the edge (15).

In order to facilitate an intuitive perception in particular of the cutoff section (14) of a print page 7 it is proposed that in a joint depiction of use section (6) and cutoff section (14) at least one dimension of the cutoff section (14) is shown un-proportionally enlarged relative to the use section (6).

The invention relates to a method for visualizing a use section and at least one cutoff section through a program for graphic production on a output device of a computer, wherein the use section has an end format of a print product, and a page of the print product can be printed in the use section, and the cutoff section abuts to an edge of the use section, and has an elongated shape along the edge.

A section of a print- fold- or partial sheet in the end format of the print product is designated as use section in the context of this document, wherein said use section can be imprinted with one page of the print product. A print sheet, the planar or folded paper sheet from the print machine for producing a book, a brochure, or another print product, is always larger than the end format of the particular page of the print product. Besides the fact that several pages of a print product, or of different print products, can be printed next to each other on a print sheet, the print sheet has one or several cutoff sections next to the use section(s). For manufacturing a poster, the terms “print product” and “page of the print product” are being used in a synonymous manner in this document.

The cutoff section is located on the print sheet outside of the use section, typically has a width of at least 2 to 15 mm, and it is separated as “cutoff” during the book binding process at the latest. It provides space for the grippers of the print machine, for the first cut, for cutoff-, print- and register marks, and for color- or gray scale calibration stripes, -bars or -wedges, based on which the print quality is checked during image printing, and the exact coloration is adjusted.

The cutoff section of the first page of a print sheet receives e.g. the sheet norm, thus, in an abbreviated manner, the book title with the edition designation and the sheet signature with the current number and the number of the print sheets. Other markings facilitate the handling of the imprinted and/or folded print sheet. The bars which are disposed on each folded back of a sheet are called “collating marks”, which facilitate the intuitive perception of their sequence for the book binder during the collating process. When the sheets are arranged correctly, the collating marks can be seen in a stepped sequence. “Cut marks” are small markings on the print sheet, showing to the bookbinder, at which location the sheet has to be cut or separated, with reference to “fold marks”, the bookbinder sees, how to fold the sheet.

Printing sheets for printing methods, e.g. offset-, letter-, gravure-, flexo- or digital print are laid out in the context of increasingly networked graphic production through generally known, highly specialized CAD (“Computer Aided Design”) systems with matched hard- and software components. Compared to manual design, such systems offer a plurality of advantages. In particular, designs for print sheets can be archived easily, and are thus available as a basis for later, similar applications. Through the linking of dimensions, CAD systems, on the one hand offer an automatic plausibility control, on the other hand, linked dimensions (e.g. the width of a cutoff section, the position or size of a marking) can be automatically adapted, when a dimension (e.g. the side format) is changed.

Such a highly specialized CAD system, which realizes a method for visualizing the print sheet, or parts of it as described above, is sold e.g. under the trade name of “PREPS” by Creo Inc., Canada. Various views are available in a visualization module for displaying the print sheet on an output device of a computer (on a monitor, a beamer, or a printer) in the context of the known CAD system. The print sheet can be depicted in an overview as a whole (scaled down), or as an expanded cutout for detail views, on one or several connected output devices. The cutoff sections, which are very narrow, compared to the use section, and the comparatively small elements, located in said cutoff section, are practically non recognizable, through the limited size and resolution of the screens which are typically used. In the illustration of enlarged cutouts, however the direct optical connection with the rest of the print sheet is missing.

The function “magnifying glass” is known from CAD-systems, through which, similar to the function of an optical magnifying glass, e.g. in the overview illustration of the print sheet, an enlarged detail can be shown. Hereby, the depicted detail in the magnifying glass area can either be enlarged proportional, or non proportional. In the first case, sections of the overview illustration, which are covered by the magnifying class, are covered, in the second case they are shown in a highly distorted manner through a continuous decrease of the magnifying factor towards the rims of the magnifying glass. Overall, the views known from the CAD systems allow an intuitive detection of the cutoff section, and of the elements located therein, relative to the remainder of the print page, only on a very limited basis.

### OBJECT

It is the object of the invention to provide a method as described above, facilitating an intuitive detection, in particular of the cutoff section of a printed page.

### SOLUTION

Based on the known methods, it is suggested according to the invention that at least one measurement of the cutoff section is shown non-proportionally enlarged, relative to the use section in a joint display of use section and cutoff section. Through the non-proportional depiction in an overview display, a dimension, which would be hardly visible based on its relative size, compared to the use section, can be visualized very easily. Through the adaptation of the dimensions, linked to the depicted dimension, in particular the side format, the use section continues to be shown next to the cutoff section, and thereby the intuitive detection is significantly facilitated relative to the known method.

In a particularly suitable embodiment of the method according to the invention, a dimension, oriented perpendicular to the edge, is shown enlarged. Thus, the cutoff section itself is distorted non-proportionally, the optical widening of a rectangular area however, can be easily recognized and interpreted as an auxiliary means for visualization by an experienced user, and can be interpreted without restricting the overall detection.

In a particularly advantageous manner, also a dimension of an element disposed in the cutoff section can be shown in an enlarged manner in the context of the method according to the invention. This way, e.g. collation-, folding-, or cutting marks perpendicular to the cutoff section can be “extended”, or calibration bars can be “widened”, and can thus be depicted so they can be detected more easily.

In a method according to the invention, suited in particular for further processing templates, the print sheet is shown with dimensions. Thus, the dimensions of the template can be easily matched with the required dimensions. Through editable dimensioning and direct modification of the display of the print sheet, after changing the dimensioning, the view for the interrelations of the particular dimensions is sharpened, and their intuitive detection is facilitated in turn.

In a particularly preferred manner, various dimensions of elements located in the cutoff section can be displayed enlarged by different factors through the method according to the invention. Thus, elements within the cutoff section can be enlarged by themselves according to the requirements of the viewer, and thereby can be quasi phased in or out. The simultaneous enlargement of all dimensions perpendicular to the longitudinal direction of the cutoff section allows a the viewer particularly good perception of the position of all elements in the cutoff section relative to each other, and relative to the cutoff section.

In a particularly advantageous embodiment of the method according to the invention factors for enlarging various elements are stored and called up under a common designation. For example, a ten-fold enlargement of all cutoff sections and all elements disposed therein, relative to the use section, can be callable under the designation “cutoff detail”, under the designation “print marks”, an enlargement of all print marks and associated cutoff sections can be callable, and under the designation “head sections”, an enlargement of all head sections can be callable from a selection list. Thus, the handling of the method according to the invention is simplified significantly.

### EMBODIMENT

The invention is subsequently explained, based on an embodiment. It is shown in:

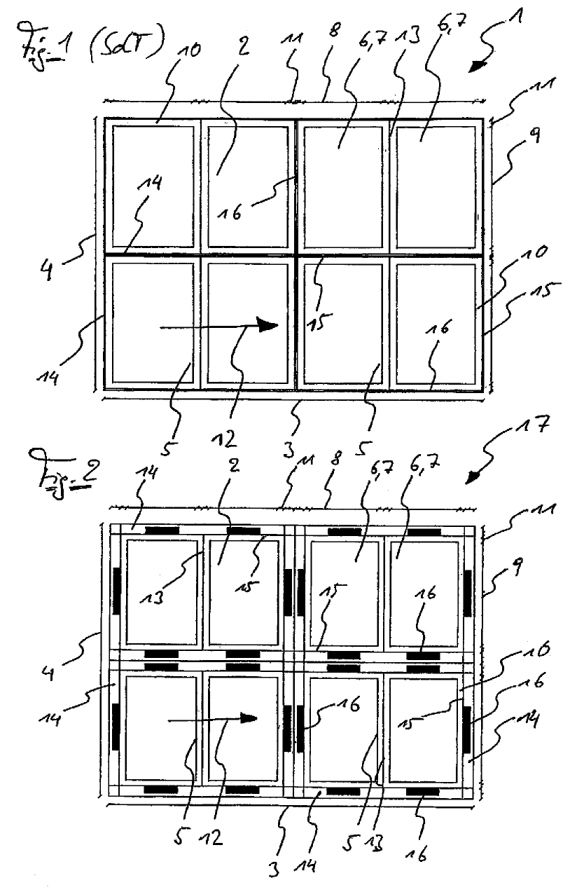

FIG. 1 proportional view of a print sheet according to the state of the art; and

FIG. 2 view of the print sheet according to the invention.

The proportional view 1 shown in FIG. 1 of a print sheet 2 with a length 3 of 880 mm, and a width 4 of 630 mm (“standard format”) is known in principle from the state of the art CAD systems. The print sheet 2 has eight use sections 6, respectively associated with each other in double pages 5, in which one respective print page 7 of a print product, which is not shown in more detail, can be printed with a width 8 of 210 mm, and a height 9 of 297 mm (format DIN A4). Within each use section 6, the print page 7 is surrounded by a section 10, not to be printed, with a width 11 of 10 mm. Within the double pages 5, the use sections 6 are arranged in the running direction 12 of the paper (narrow track) with the longitudinal sides 13 disposed adjacent and behind each other. Adjacent to the double pages 5, the elongated cutoff sections 14 are disposed, in which adjacent to each use section 6 a respective longitudinal element 16 is disposed along the respective edge 15. On the print sheet 2 two double pages 5 with the associated cutoff sections 14 are disposed in running the direction 12, respectively behind each other and next to each other.

FIG. 2, on the other hand, shows a view 17 according to the invention on a monitor, which is not shown, of a program for a (networked) graphic production, in particular a management information system (MIS), or a program for controlling an execution system, like e.g. a preprint stage, a plate exposition machine, a printing-, folding-, or cutting machine.

In the view 17 the cutoff sections 14 of the print sheet 2 known from FIG. 1, are depicted un-proportionally enlarged relative to its use sections 6, through a widening perpendicular to the edges 15, and the use sections 6 are depicted correspondingly reduced, according to a method according to the invention. Thereby, the cutoff sections 14, and therein the elements 16 are optically significantly emphasized, and simultaneously their position in the context of the print sheet 2 is intuitively perceived by a person skilled in the art.

The visualization of the print sheet 2 according to the invention on a output device, which is greatly downsized in dimension, and also in resolution, compared to the real print sheet, allows the person skilled in the art, who plans the graphic production with this program, controls it, monitors it, or operates an execution system, a significantly simplified, and compared to the known systems, also a safer assessment of the disposition of the elements 16 in the cutoff sections 14, and in their spatial orientation relative to the use sections 6 on the print sheet 2.

The double pages 5, the use sections 6, longitudinal sides 13, cutoff sections 14 and elements 16 are shown in the figures only with exemplary numerals in order to achieve a clear presentation.

### DESIGNATIONS IN THE FIGURES

1 view
2 print sheet
3 length
4 width
5 double page
6 use section
7 print page
8 width
9 height
10 section not be printed
11 width
12 running direction
13 longitudinal side
14 cutoff section
15 edge
16 element
17 view

1. A method for visualizing a use section (6) and at least one cutoff section (14) through a program for graphic production on an output device of a computer, wherein the use section (6) has an end format of a print product, and a page of the print product can be printed in the use section (6), and the cutoff section (14) abuts to an edge (15) of the use section (6), and has an elongated shape along the edge (15), wherein in a joint depiction of use section (6) and cutoff section (14) at least one dimension of the cutoff section (14) is shown un-proportionally enlarged relative to the use section (6).

2. A method according to claim 1, wherein a dimension perpendicular to the edge (15) is shown enlarged.

3. A method according to claim 1, wherein at least one measurement of an element (16) disposed in the cutoff section (14) is shown enlarged.

4. A method according to claim 1, wherein the print page is shown with dimensions.

5. A method according to claim 4, wherein the dimensioning can be edited, and the print page is shown according to the changed dimensioning after changing the dimensioning.

6. A method according to claim 3, wherein the different dimensions of elements (16) disposed in the cutoff section (14), are shown enlarged by independent factors.

7. A method according to claim 6, wherein several use sections (6) of a print-, fold- or partial sheet are shown together with the adjacent cutoff sections (14), and identical elements of different cutoff sections (14) are shown with the same enlargement.

8. A method according to claim 7, wherein factors for enlarging various elements (16) are stored and called up under a common designation.
